(19) United States
(12) Patent Application Publication
(10) Pub. No.: US 2019/0089747 A1
(43) Pub. Date: Mar. 21, 2019

(54) PROTECTING SECURE SESSION FROM IOT GATEWAYS

(71) Applicant: Cisco Technology, Inc., San Jose, CA (US)

(72) Inventors: Wenyi Wang, Cupertino, CA (US); Rashmikant B. Shah, San Jose, CA (US); Brian Weis, San Jose, CA (US); Michael L. Sullenberger, San Jose, CA (US); Yuan Cai, San Jose, CA (US)

(21) Appl. No.: 15/708,453

(22) Filed: Sep. 19, 2017

(51) Int. Cl. H04L 29/06; H04L 9/08

(52) U.S. Cl. CPC H04L 63/205; H04L 63/0263; H04L 63/1441; H04L 63/0281; H04L 63/029; H04L 63/0272; H04L 9/0841

(57) ABSTRACT

A process to protect secure communication sessions from a network device that may have been subjected to a malicious network attack or otherwise the source of malicious network traffic. A cellular-connected network device, such as an IoT gateway, may receive data from one or more IoT devices. The cellular-connected network device may also communicate with a datacenter via a communication tunnel. The network device may include a usage profile reference. The network device, before transmitting data received from the IoT devices, may transmit the usage profile reference to the datacenter for authentication purposes. The datacenter may use the usage profile reference to resolve a usage profile that the usage profile reference references. Using the usage profile, the datacenter may negotiate with the cellular-connected network device to restrict the types of data that is transmitted between the datacenter and the cellular-connected network device.

### TECHNICAL FIELD

This disclosure relates to network security of traffic from an Internet-of-Things (IoT) device.

### BACKGROUND

IoT devices, such as smart thermostats, smart refrigerators, and smart lightbulbs, are devices that have a limited number of functions and use limited network resources. IoT application servers may collect data received from IoT devices and/or send commands to the IoT devices. IoT devices may communicate with IoT application servers using network devices, such as IoT gateways. When the IoT gateway communicates with the IoT application servers using a communication tunnel, the network traffic transmitted through the communication tunnel bypasses policies, such as access control lists, which limits the types of network traffic accepted by the IoT application server. This may leave the IoT application server vulnerable to malicious network traffic transmitted by the IoT gateway.

Accordingly, there is a need to protect an IoT communication system, which may include IoT application servers, IoT gateways, and IoT devices, from malicious network traffic.

### BRIEF DESCRIPTION OF THE DRAWINGS

FIG. 1 is a block diagram showing an example of a network in which protection against malicious network traffic from a network device may be employed, according to an example embodiment.

FIG. 2 is a more detailed block diagram of IoT gateway, according to an example embodiment.

FIG. 3 is a diagram of communication paths between a mobile network-connected IoT gateway to a datacenter and a local area network (LAN)-connected IoT gateway to the datacenter, according to an example embodiment.

FIG. 4 is a diagram illustrating a system configured to protect a datacenter from a cellular-connected IoT gateway, according to an example embodiment.

FIG. 5 is a diagram illustrating a system in which there is an encrypted communication tunnel using the Internet Key Exchange (IKE) protocol between a cellular-connected IoT gateway and a datacenter, according to an example embodiment.

FIG. 6 is a ladder diagram illustrating a flow of data between the IoT gateway and the datacenter, according to an example embodiment.

FIG. 7 is a high-level flowchart of a method for protecting secure sessions from IoT gateways, according to an example embodiment.

FIG. 8 is a block diagram showing a server configured to communicate with the IoT gateway using the techniques described herein, according to an example embodiment.

### DESCRIPTION OF EXAMBLE EMBODIMENTS

### Overview

Presented herein is a process that may protect an IoT communication system, which may include IoT devices, IoT gateways, and IoT application servers from a malicious network attack or otherwise malicious network traffic. A cellular-connected network device may receive data from one or more IoT devices. The cellular-connected network device may also communicate with a datacenter via a communication tunnel. The network device may include a usage profile reference. The network device, before transmitting data received from the IoT devices, may transmit the usage profile reference to the datacenter for authentication purposes. The datacenter may use the usage profile reference to resolve a usage profile that the usage profile reference references. Using the usage profile, the datacenter may negotiate with the cellular-connected network device using a policy, such as an access control list, to restrict the types of data that is transmitted between the datacenter and the cellular-connected network device. In another example embodiment, the process may similarly protect IoT devices and IoT gateways from malicious traffic being transmitted by the datacenter.

### Example Embodiments

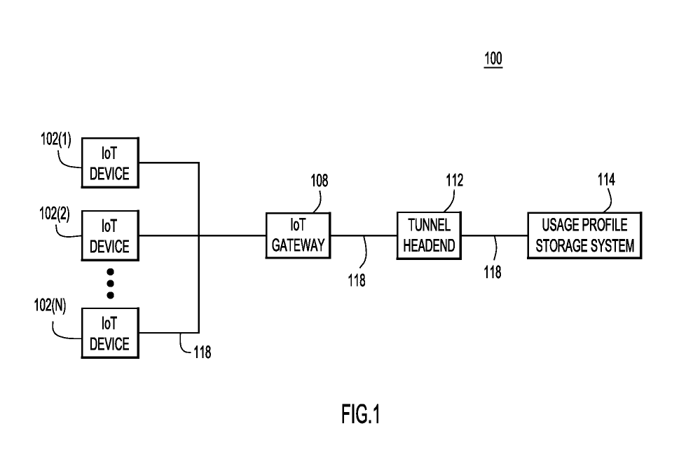

With reference made first to FIG. 1, FIG. 1 is a block diagram showing an example of a network 100 in which protection against malicious network traffic from a network device may be employed, according to an example embodiment. FIG. 1 shows multiple IoT devices 102(1)-102(N). The term “network device” is meant to be interpreted broadly. For example, network devices may include IoT devices 102(1)-102(N). Network devices may also include intermediary devices, such as IoT gateway 108. Such IoT devices may include thermostats, refrigerators, and lightbulbs. However, one of ordinary skill in the art would readily recognize that the IoT device may be any type of device now known or hereinafter developed. Additionally, one of ordinary skill in the art would readily recognize that other network-capable devices, and not just IoT devices, may also be in network 100. However, by way of example only, this disclosure will describe the systems, methods, and apparatus of this disclosure using IoT devices.

The IoT devices 102(1)-102(N) may be connected to IoT gateway 108. The IoT gateway 108 may be connected to a tunnel headend 112 via a communication network 118. However, the IoT gateway may not always be present. For example, the IoT devices 102(1)-102(N) themselves may be connected to the tunnel headend 112 via the communication network 118. This disclosure will describe a system in which IoT gateway 108 is present. The connection between the IoT gateway 108 and the tunnel headend 112 is described in more detail below. The tunnel headend 112 may be connected to user profile storage system 114. The communication network 118 may be, for example, a local access network (LAN) or wide area network (WAN). Also, the communication network 118 may be either wired, wireless, or a combination of wired and wireless. The IoT gateway 108 is described in more detail below. The communication and operation of the tunnel headend 112 and the usage profile storage system 114 are also described in more detail below.

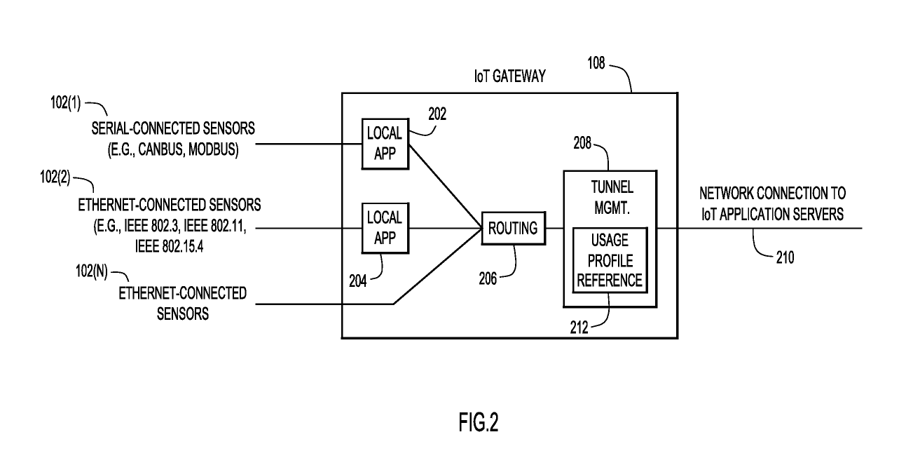

With reference made to FIG. 2, FIG. 2 is a more detailed block diagram of IoT gateway 108, according to an example embodiment. As shown in FIG. 2, the IoT gateway 108 may be connected to a variety of IoT devices 102(1)-102(N) and may communicate with the IoT devices 102(1)-102(N) over a variety of protocols. For example, the IoT gateway 108 may be connected to one or more serial-connected IoT devices. The IoT gateway 108 may communicate with these IoT devices using, for example, the Controller Area Network (CAN) bus protocol or the Modbus protocol. The IoT gateway 108 may also be connected to one or more Ethernet-connected IoT devices. The IoT gateway 108 may communicate with these IoT devices using, for example, the IEEE 802.3, 802.11, and 802.15.4 communication protocols.

The IoT gateway 108 may also include a plurality of modules, such as a local application 202, a local application 204, a routing module 206, and a tunnel management module 208. The local applications 202, 204 may be configured to receive inputs from serial-connected IoT devices and Ethernet-connected IoT devices, respectively. For example, local application 202 may be connected to an IoT thermostat. Local application 202 may receive data, such as a sensed temperature or a change to a thermostat setting, in a first protocol from the IoT thermostat. Local application 202 may process this data and translate the data from the first protocol to a second protocol. Additionally, local applications 202, 204 may be IoT applications executing within a “fog” network. Local applications 202, 204 may increase system responsiveness and an ability to process a large volume of data.

The routing module 206 receives as inputs the outputs of local applications 202, 204. The routing module 206 may also receive as an input data from IoT devices that are not inputs to a local application. In FIG. 2, some Ethernet-connected IoT devices are connected to the routing module 206 rather than to a local application 202, 204. One of ordinary skill in the art would readily recognize that other IoT devices connected to the IoT gateway 108 via means other than Ethernet may also connect to the routing module 206 rather than a local application 202, 204. The routing module 206 may include instructions for routing the network traffic, such as data received from the IoT devices, it receives. For example, the routing module 206 may include a routing table. The routing module 206 may use the routing table to determine a destination for the network traffic. When the routing module 206 has determined the destination for the network traffic, the routing module 206 may transmit the network traffic to tunnel management module 208.

Tunnel management module 208 may be used to set up and transmit network traffic via a communication tunnel 210 to an endpoint, such as the tunnel headend 112. In one aspect, communication tunnel 210 may be encrypted. Also, a portion of the communication tunnel 210 may traverse at least a part of a mobile (i.e., cellular) network. The IoT gateway 108 may also include a usage profile reference 212 associated with the gateway 108 in, for example, the tunnel management module 208. The usage profile reference 212 may be in the form of a Uniform Resource Identifier (URI) and reference a usage profile. In general, the usage profiles are configuration profiles or templates associated with one or more IoT devices 102(1)-102(N). The usage profiles each identify (i.e., include, describe, and/or reference) preselected (predetermined) usage descriptions associated with the respective IoT device. The usage descriptions include information that affects how to configure networking policies across the network infrastructure (i.e., information that can be used by the network infrastructure to determine the appropriate usage, role, policies, etc. for the IoT devices 102(1)-102(N)). In one aspect of this disclosure, the tunnel management module 208 may have one usage profile reference 212. Since the gateway 108 may be connected to multiple IoT devices 102(1)-102(N), the usage profile reference 212 of the IoT gateway 108 may include a summary of the usage profile reference for each IoT device 102(1)-102(N) connected to the IoT gateway 108. In another aspect of this disclosure, the tunnel management module 208 may include a usage profile reference 212 for each IoT device 102(1)-102(N) connected to the IoT gateway 108.

A number of different usage descriptions may be set for corresponding ones of the IoT devices 102(1)-102(N). These usage descriptions may include, for example, description of the role of the IoT device, policies, such as access control policies, quality of service (QoS) policies (e.g., traffic prioritization), indication of network required services (e.g., web/Transport Layer Security (TLS) proxy functions, malware scanning, Domain Name System (DNS), network authentication, etc.), protocol usage restrictions, application (type) restrictions, and/or other policies. In certain examples, groups of statements may be conditioned on options found in the usage profile reference 212.

In certain examples, the predetermined usage descriptions are referred to herein as being “manufacturer-driven” or “manufacturer-based” usage descriptions (MUDs) because they may indicate the manufacturer's operational requirements and/or intent for the corresponding special purpose network connected device. For instance, the IoT device 102(1) may be a thermostat device that, according to the manufacturer, may only need to contact its controller, which it knows by a hostname. As such, the manufacturer sets a policy, such as an access control policy, indicating that the thermostat device can only communicate with its associated controller. In such examples, the manufacturer-based usage descriptions are used to configure the tunnel management modules for access control mechanisms to enforce this policy (i.e., monitoring Domain Name Server (DNS) queries and responses, and for applying appropriate access rules to limit communications between the IoT 102(1) and its corresponding controller (not shown)). One example of a policy is an access control list.

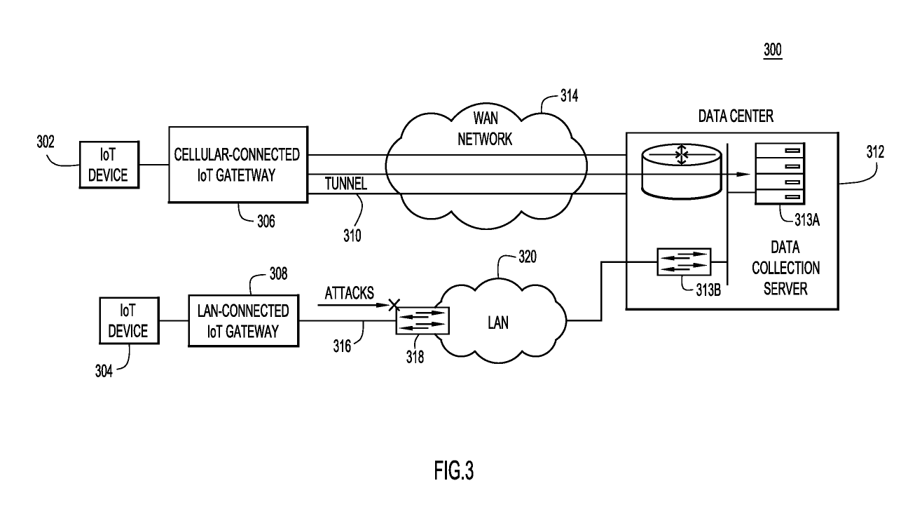

Reference is now made to FIG. 3. FIG. 3 is a diagram of communication paths between a mobile network-connected IoT gateway to a datacenter and a local area network (LAN)-connected IoT gateway to the datacenter, according to an example embodiment. FIG. 3 shows IoT device 302 connected to a cellular-connected IoT gateway 306 and IoT device 304 connected to LAN-connected IoT gateway 308. Cellular-connected IoT gateway 306 communicates with datacenter 312 over a communication tunnel 310 to datacenter 312 via wide area network (WAN) network 314. LAN-connected IoT gateway 308 communicates over a communication path 316 through a network element 318 of a LAN 320 to datacenter 312. Network element 318 could be a network access switch or router. The datacenter 312 includes a data collection server (e.g., IoT server) 313A and network elements 313B. LAN-connected IoT gateway 308 may have a structure similar to the IoT gateway 108, described above. In this example, LAN-connected IoT gateway 308 may be compromised. In other words, LAN-connected IoT gateway 308 may be transmitting malware, or other undesired network traffic, to the datacenter 312 over communication path 316 in addition to legitimate data from the IoT device 304, to the datacenter 312. However, policies, such as access control lists (ACLs), may be applied to the access ports of the enterprise network at the network element 318 to which the LAN-connected IoT gateway 308 is connected. The policies, such as ACLs, may be derived from usage profiles. These policies protect the enterprise network from malicious network traffic sent from the LAN-connected IoT gateway 308 by specifying which types of traffic are accepted on the access ports of the datacenter 312. The policies may be based on the type of network traffic expected from the LAN-connected IoT gateway 308. For example, if one of the IoT devices 304 was a refrigerator, a policy, such as an ACL, may not accept network traffic related to, for example, emails when examining network traffic from the refrigerator. The policies may be enforced at router 318 Therefore, in the LAN-connected IoT gateway scenario, the datacenter 312 is protected from malicious traffic sent from the LAN-connected IoT gateway 308.

The communication path between the cellular-connected IoT gateway 306 and the datacenter 312, IoT device 302 is managed differently when the cellular-connected IoT gateway 306 may be compromised. In contrast to the LAN-connected IoT gateway 308 example above, policies, such as ACLs, may not be applied to the access ports of the enterprise network to which the cellular-connected IoT gateway 306 is connected. This is because the network traffic transmitted from the cellular-connected IoT gateway 306 to the datacenter 312 is communicated via communication tunnel 310 over WAN 314. Therefore, the datacenter 312 is vulnerable to malware sent from cellular-connected IoT gateway 306.

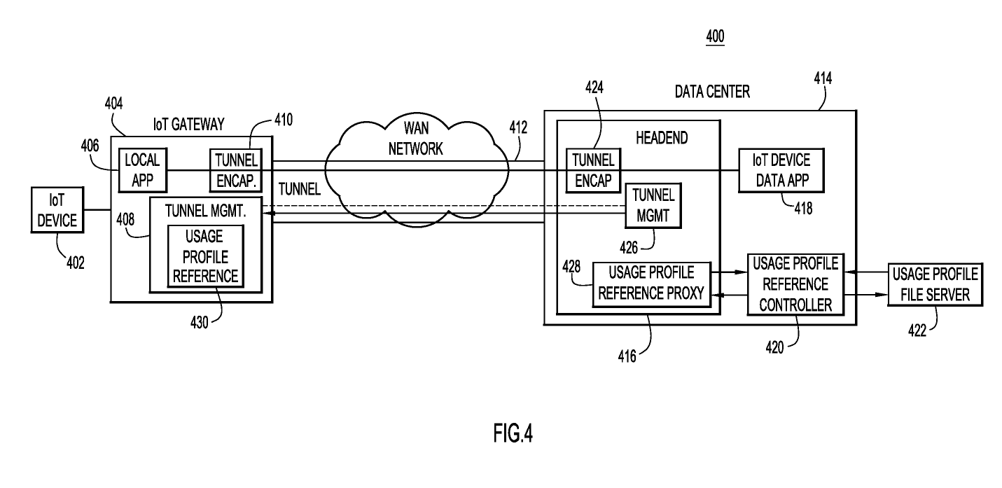

With reference made to FIG. 4, FIG. 4 is a diagram illustrating a system 400 configured to protect a datacenter from a cellular-connected IoT gateway, according to an example embodiment. As shown in FIG. 4, IoT device 402 may be connected to cellular-connected IoT gateway 404. Cellular-connected IoT gateway 404 may have a local application 406, a tunnel management module 408, and a tunnel encapsulation module 410. Data received from the IoT device 402 may be received at the cellular-connected IoT gateway 404. For example, the local application 406 may receive the IoT device data. The local application 406 may be an IOx application. After the local application 406 processes the IoT device data, the processed IoT device data may be transmitted to the tunnel encapsulation module 410. For example, the local application 406 may process the IoT device data by translating the data from a first protocol to a second protocol. The tunnel encapsulation module 410 may then prepare the processed IoT device data for transmission using a communication protocol via the communication tunnel 412. The communication protocol may be, for example, TCP/IP. The tunnel management module 408 may manage the communication tunnel 412 on behalf of the cellular-connected IoT gateway 404.

The cellular-connected IoT gateway 404 may have a usage profile reference 430 associated with it. The usage profile reference 430 may include usage profile references for each of the IoT devices 402 connected to the cellular-connected IoT gateway 404. Additionally, the usage profile reference 430 may be a MUD URI using the X.509 extension. The usage profile reference 430 may be transmitted to the datacenter 414 via the communication tunnel 412.

The communication tunnel 412 may be configured to transmit encapsulated IoT device data from the cellular-connected IoT gateway 404 to the datacenter 414. The datacenter 414 may include a headend 416, an IoT device data application 418, and a usage profile reference controller 420. The datacenter 414 may also be connected to a usage profile file server 422. The usage profile file server 422 may include one or more devices (e.g., servers) that are configured to store usage profiles associated with one or more IoT devices.

The headend 416 may further comprise a tunnel encapsulation module 424, a tunnel management module 426, and a usage profile reference proxy 428. For example, as shown in FIG. 4, the system 400 may use a MUD as the usage profile. One of ordinary skill in the art would readily recognize that usage profiles other than MUD and a usage profile reference other than X.509 may be used.

The datacenter 414 may receive the usage profile reference 430 associated with the cellular-connected IoT gateway 404 at the datacenter tunnel management module 426. The datacenter 414 may authenticate the cellular-connected IoT gateway 404 using the received usage profile reference 430. The datacenter tunnel management module 416 may provide the usage profile reference 430 to the usage profile reference proxy 428. The usage profile reference proxy 428 may then output the usage profile reference 430 to the usage profile reference controller 420. The usage profile reference controller 420 may then resolve the usage profile reference 430. For example, the usage profile reference controller 420 may resolve the usage profile reference 430 by transmitting a usage profile reference query to the usage profile file server 422.

In one example, the usage profile file server 422 is part of a website (e.g., a webpage) associated with a manufacturer of an IoT device. Based on the information included in the usage profile reference, the usage profile file server 422 may generate the usage profile the usage profile reference references.

The usage profile file server 422 may then transmit the generated usage profile to the usage profile reference controller 420, which may then provide the usage profile to the usage profile reference proxy 428. The usage profile may include a policy, such as an ACL. The policy may indicate which types of data that the datacenter 414 accepts from the cellular-connected IoT gateway 404. The usage profile reference proxy 416 may then provide the usage profile to the datacenter tunnel management module 426.

The datacenter tunnel management module 426 may use the usage profile to negotiate with the cellular-connected IoT gateway 404 for the types of traffic that the datacenter 414 accepts from the cellular-connected IoT gateway 404 over the communication tunnel 412. For example, the cellular-connected IoT gateway 404 may offer broad traffic selectors to the datacenter 414. The tunnel management module 426 may negotiate to accept a subset of the traffic selectors offered by the cellular-connected IoT gateway 404 based on the policy returned by the usage profile file server 422. In another aspect, the datacenter tunnel management module 426 may forward the usage profile, policy, and traffic selectors to the cellular-connected IoT gateway 404. The cellular-connected IoT gateway 404 may then enforce the network traffic restrictions. In another aspect, the datacenter tunnel management module 426 may enforce the network traffic restrictions to traffic sent by IoT gateway 404 over the communication tunnel 412.

By restricting the types of traffic that the datacenter 414 accepts, the datacenter 414 mitigates the possibility that malicious or undesired network traffic transmitted by the cellular-connected IoT gateway 404 is accepted at the datacenter 414, which in turn mitigates the possibility that the datacenter 414 becomes compromised. Moreover, since the cellular-connected IoT gateway 404 uses a cellular connection, which are often metered connections, network traffic that will not be accepted by the datacenter 414 is not transmitted and, therefore, does not count against the metered connection data limits.

While FIG. 4 described network traffic being sent from IoT device 402 and IoT gateway 404 to the datacenter 414, the techniques of this disclosure may also be applied to traffic being sent from the datacenter 414 to the IoT gateway 404 and IoT device 402. In this scenario, the IoT gateway 404 and IoT device 402 may be protected from malicious network traffic that otherwise may have been transmitted from the datacenter 414.

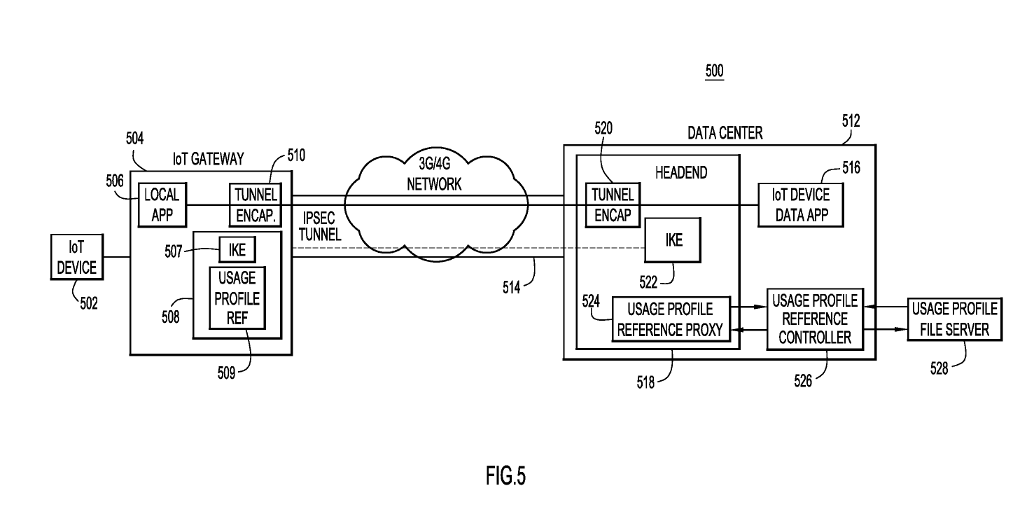

With reference made to FIG. 5, FIG. 5 is a diagram illustrating a system 500 in which there is an encrypted communication tunnel using the Internet Key Exchange (IKE) protocol between a cellular-connected IoT gateway and a datacenter, according to an example embodiment. FIG. 5 is similar FIG. 4 except that FIG. 5 is an example embodiment where IKE is used. IoT device 502 may be connected to and transmit data to the cellular-connected IoT gateway 504. The cellular-connected IoT gateway 504 may include a local application 506, a tunnel management module 508, which may include an IKE module and a usage profile reference 509, and a tunnel encapsulation module 510. Data received from the IoT device 502 may be received at the cellular-connected IoT gateway 504. For example, the local application 506 may receive the IoT device data. The local application 506 may be an IOx application. After the local application 506 processes the IoT device data, the processed IoT device data may be transmitted to the tunnel encapsulation module 510. For example, the local application 506 may process the IoT device data by translating the data from a first protocol to a second protocol. After the local application 506 processes the IoT device data, the processed IoT device data may be transmitted to the cellular-connected IoT gateway tunnel encapsulation module 510. The tunnel encapsulation module 510 may then prepare the processed IoT device data for transmission using a communication protocol via an encrypted communication tunnel 514. For example, the encrypted communication tunnel 514 may use the Internet Protocol Security (IPSec) protocol suite for encryption. Moreover, the encrypted communication tunnel 514 may be used as part of a virtual private network (VPN) connection.

The IKE module 507 may perform tunnel management on behalf of the cellular-connected IoT gateway 504, such as that performed by the tunnel management module 408, as described in FIG. 4. The tunnel management module 508 may also include a usage profile reference 509. The usage profile reference 509 may be a MUD URI using the X.509 extension. The usage profile reference 509 may include usage profile references for each IoT device 502 connected to the cellular-connected IoT gateway 504. In other words, although FIG. 5 shows a single IoT device 502 it is to be understood that a plurality of IoT devices may be connected to the gateway 504. The usage profile reference 509 may be transmitted to the datacenter 512 via the encrypted communication tunnel 514. In general, the encrypted communication tunnel 514 may be configured to transmit encapsulated IoT device data from the cellular-connected IoT gateway 504 to the datacenter 512.

The datacenter 512 may include an IoT device data application 516, tunnel encryption module 518, which may include tunnel encapsulation module 520, IKE module 522 and usage profile reference proxy 524, and usage profile reference controller 526. For example, the system 500 may use a MUD as the usage profile. One of ordinary skill in the art would readily recognize that usage profiles other than MUD may be used. The tunnel encapsulation module 520 receives network traffic communicated over the encrypted communication tunnel 514 from the cellular-connected IoT gateway 504. The tunnel encapsulation module 520 may de-encapsulate the received data and output the de-encapsulated data to IoT device data application 516, which may be configured to receive such network traffic at the datacenter 512. The usage profile reference proxy 524 may be a function included in an IKE daemon or a separate, trusted program, for example.

The datacenter 512 may also be connected to a usage profile storage system 114. In FIG. 5, the aforementioned usage profile storage system may be implemented by a usage profile file server 528.

The IKE module 507 located in the tunnel management module 508 on the cellular-connected IoT gateway 504 may communicate with IKE module 522 located in the datacenter 512. The datacenter IKE module 522 may receive the usage profile reference 509 associated with the cellular-connected IoT gateway 504. The datacenter 512 may authenticate the cellular-connected IoT gateway 504 using the received usage profile reference 509. After the data center IKE module 522 receives a usage profile reference 509 from tunnel management module 508 via the IKE module 507, the datacenter IKE module 522 may output the usage profile reference 509 to the usage profile reference proxy 524. The usage profile reference proxy 524 may then transmit the usage profile reference 509 to the usage profile reference controller 526. The usage profile reference proxy 524 may also transmit traffic selectors to the usage profile reference controller 526. The usage profile reference controller 526 may resolve the usage profile reference 509. For example, the usage profile reference controller 526 may transmit the usage profile reference 509 to the usage profile reference file server 528 as part of a usage profile reference file query. The usage profile reference file server 528 generates, based on the usage profile reference file query, the usage profile that the usage profile reference 509 references. The usage profile may include a policy, such as an ACL. The policy may indicate which types of data that the datacenter 512 accepts from the cellular-connected IoT gateway 504. In one example, the usage profile storage system 114 is part of a web site (e.g., a webpage) associated with a manufacturer of an IoT device.

The usage profile file server 528 may then transmit the generated usage profile to the usage profile reference controller 526, which may then output the usage profile to the usage profile reference proxy 524. The usage profile reference proxy 524 may translate the policy of the usage profile into traffic selectors. IKE version 2 may use these traffic selectors to generate a payload that restricts the types of traffic that the datacenter 512 accepts or transmits to IoT gateway 504 over encrypted communication tunnel 514. The usage profile reference proxy 524 may then output the usage profile, the policy, and the traffic selectors to the datacenter IKE module 522.

The datacenter IKE module 522 may use the usage profile to negotiate with the IKE module 507 of the cellular-connected IoT gateway 504 for the types of traffic that the datacenter 512 accepts from and sends to the cellular-connected IoT gateway 504 over the encrypted communication tunnel 514. For example, the datacenter IKE module 522 may include the traffic selectors in its IKE_AUTH response message to the IKE module 507 in the cellular-connected IoT gateway 504. In another aspect, the IKE module 522 may forward the usage profile, policy, and traffic selectors to the IKE module 507 in the cellular-connected IoT gateway 504. In another aspect, the IKE module 522 may apply the traffic selectors to packets that are received and sent over the encrypted communication tunnel 514 without first negotiating them. The cellular-connected IoT gateway 504 may also enforce these network traffic restrictions.

By restricting the types of traffic that the datacenter 512 accepts, the datacenter 512 mitigates the possibility that malicious network traffic transmitted by the cellular-connected IoT gateway 504 is accepted at the datacenter 512, which in turn mitigates the possibility that the datacenter 512 becomes compromised. Moreover, since the cellular-connected IoT gateway 504 uses a cellular connection, which are often metered connections, network traffic that will not be accepted by the datacenter 512 is not transmitted and, therefore, does not count against the metered connection data limits.

While FIG. 5 described network traffic being sent from IoT device 502 and IoT gateway 504 to the datacenter 512, the techniques of this disclosure may also be applied to traffic being sent from the datacenter 512 to the IoT gateway 504 and IoT device 502. In this scenario, the IoT gateway 504 and IoT device 502 may be protected from malicious network traffic that otherwise may have been transmitted from the datacenter 512.

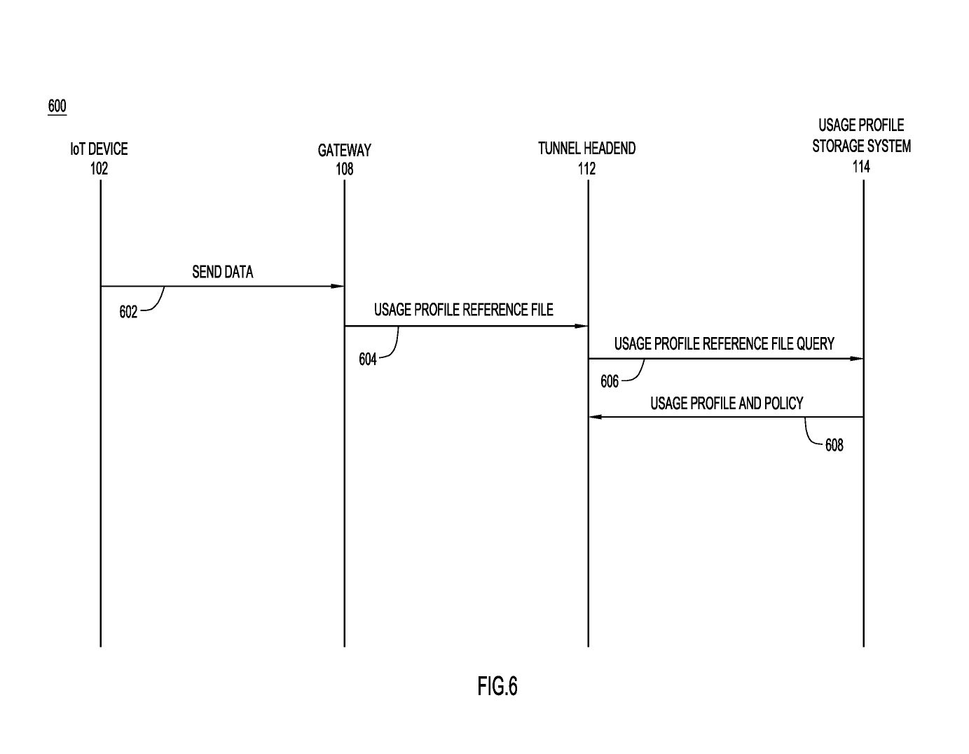

With reference made to FIG. 6, FIG. 6 is a ladder diagram illustrating a flow of data between the IoT gateway and the datacenter, according to an example embodiment. Reference is also made to FIG. 1 for purposes of the description of FIG. 6. At 602, IoT device 102 transmits data to the cellular-connected IoT gateway 108. For example, IoT device 102 may be a thermostat. In this example, the thermostat may transmit a temperature and/or a changed temperature setting to the cellular-connected IoT gateway 108. The cellular-connected IoT gateway 108 may receive this data in the data format transmitted by the IoT device 102. The cellular-connected IoT gateway 108 may translate the data from the IoT device 102 to a second data format for use at the tunnel headend 112, which may be located in a datacenter, such as datacenter 414 or 512.

Before the cellular-connected IoT gateway 108 may transmit the data to the tunnel headend 112, the cellular-connected IoT gateway 108 establishes a connection with the tunnel headend 112. The cellular-connected IoT gateway 108 may communicate with the tunnel headend 112 using a communication tunnel, such as communication tunnel 412 of FIG. 4 or communication tunnel 514 of FIG. 5. The cellular-connected IoT gateway 108 may transmit a usage profile reference file to authenticate with the tunnel headend 112. This is represented at 604 in FIG. 6.

At 606, the tunnel headend 112 may transmit a usage profile reference file query to the usage profile storage system 114. The usage profile reference query may be based on the received usage profile reference file from the cellular-connected IoT gateway 108. The usage profile storage system 114 may determine the usage profile corresponding to the usage profile reference query. The determined usage profile may include a policy, such as an ACL, which may provide restrictions on which types of network traffic to accept from the cellular-connected IoT gateway 108 at the tunnel headend 112. At 608, the usage profile storage system 114 may transmit the usage profile and policy to the tunnel headend 112.

The tunnel headend 112 may use the usage profile and policies, such as an access control list, to restrict the types of network traffic the tunnel headend 112 accepts from the cellular-connected IoT gateway 108. For example, the tunnel headend 112 and the cellular-connected IoT gateway 108 may negotiate the types of network traffic to accept and transmit, respectively. For example, the cellular-connected IoT gateway 108 may offer a list of initial traffic selectors to the tunnel headend 112. Based on the usage profile and the policy returned by the usage profile storage system 112, the tunnel headend 112 may select a subset of the initial traffic selectors to accept.

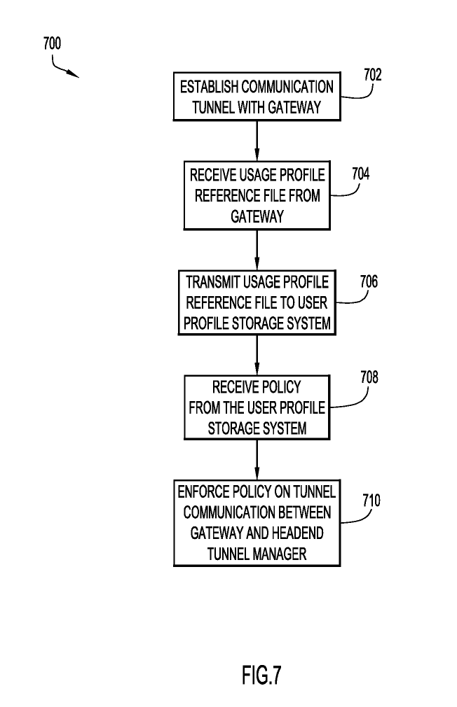

With reference made to FIG. 7, a high-level flowchart is shown of a method 700 for protecting secure sessions from IoT gateways, according to an example embodiment. Method 700 may start at operation 702. At operation 702, the gateway 108 and the tunnel headend 112 may establish a communication channel, such as communication tunnel 412 or 514, with each other. After operation 702 is completed, the method 700 may proceed to operation 704.

At operation 704, the tunnel headend 112 may receive a usage profile reference file from the gateway 108. The usage profile reference file may be as described above in connection with FIGS. 2-5. After operation 704 is completed, the method 700 may proceed to operation 706.

At operation 706, the tunnel headend 112 may transmit a usage profile reference query using the user profile reference file to the user profile storage system 114 to retrieve a usage profile and associated policies, such as an access control list. After operation 706 is completed, the method 700 may proceed to operation 708.

At operation 708, the tunnel headend 112 may receive the usage profile, which may include a policy, such as an access control list, retrieved from the usage profile storage system 114. After operation 708 is completed, the method 700 may proceed to operation 710.

At operation 710, the tunnel headend 112 may enforce the policy, such as the access control list, on tunnel communications between the gateway 108 and the tunnel headend 112. In one aspect of this disclosure, the tunnel headend 112 may enforce the policy on network traffic transmitted to the gateway 108. In another aspect, the tunnel headend 112 may enforce the policy on network traffic received from the gateway 108. In another example, the policy may be enforced on both network traffic transmitted to the gateway 108 and received from the gateway 108. In still another embodiment, the policy may be forwarded to the gateway 108 and the policy enforced by/at the gateway 108.

A number of improvements may be made to the techniques described above. For example, in one aspect of this disclosure, the usage profile reference is a MUD reference and the usage profile storage system is a MUD server.

In another aspect, the tunnel headend and the network device may enforce the policy by negotiating to restrict a type of network traffic that the tunnel headend accepts to protect secure sessions from compromised network devices.

In another example embodiment, the policy generated by a usage profile file server is transmitted to the network device. The network device may then enforce the policy.

In yet another aspect, based on the policy, IKE traffic selectors may be generated to restrict a type of network traffic that the headend tunnel manager accepts.

In another example, the communication tunnel may traverse at least one part of a mobile or a cellular network. In another aspect, the communication tunnel may be a VPN tunnel.

In another embodiment, the network device is an IoT gateway. The IoT gateway may be connected to a plurality of IoT devices. Also, the usage profile reference may be a summary of usage profile references associated with each IoT device connected to the IoT gateway.

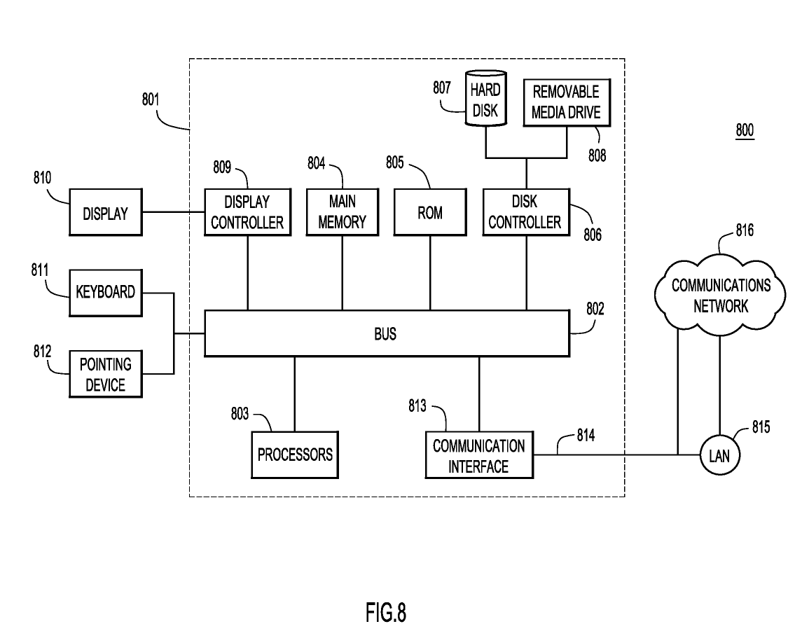

With reference made to FIG. 8, FIG. 8 is a block diagram showing a server 800 configured to communicate with the IoT gateway using the techniques described herein, according to an example embodiment. This server 800 may reside in a datacenter, such as shown in FIGS. 3-5, and perform the operations described above with respect to FIGS. 3-7. For example, the server 800 may be an IoT server residing in a datacenter. FIG. 8 a computer system 801 of server 800 upon which the embodiments presented may be implemented. The computer system 801 includes a bus 802 or other communication mechanism for communicating information, and a processor 803 coupled with the bus 802 for processing the information. While the figure shows a signal block 803 for a processor, it should be understood that the processors 803 represent a plurality of processing cores, each of which can perform separate processing. The computer system 801 also includes a main memory 804, such as a random access memory (RAM) or other dynamic storage device (e.g., dynamic RAM (DRAM), static RAM (SRAM), and synchronous DRAM (SD RAM)), coupled to the bus 802 for storing information and instructions to be executed by processor 803. In addition, the main memory 804 may be used for storing temporary variables or other intermediate information during the execution of instructions by the processor 803.

The computer system 801 further includes a read only memory (ROM) 805 or other static storage device (e.g., programmable ROM (PROM), erasable PROM (EPROM), and electrically erasable PROM (EEPROM)) coupled to the bus 802 for storing static information and instructions for the processor 803.

The computer system 801 also includes a disk controller 806 coupled to the bus 802 to control one or more storage devices for storing information and instructions, such as a magnetic hard disk 807, and a removable media drive 808 (e.g., floppy disk drive, read-only compact disc drive, read/write compact disc drive, compact disc jukebox, tape drive, and removable magneto-optical drive). The storage devices may be added to the computer system 801 using an appropriate device interface (e.g., small computer system interface (SCSI), integrated device electronics (IDE), enhanced-IDE (E-IDE), direct memory access (DMA), or ultra-DMA).

The computer system 801 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)), that, in addition to microprocessors and digital signal processors may individually, or collectively, are types of processing circuitry. The processing circuitry may be located in one device or distributed across multiple devices.

The computer system 801 may also include a display controller 809 coupled to the bus 802 to control a display 810, such as Light Emitting Diode (LED) or Liquid Crystal Display (LCD), for displaying information to a computer user. The computer system 801 includes input devices, such as a keyboard 811 and a pointing device 812, for interacting with a computer user and providing information to the processor 803. The pointing device 812, for example, may be a mouse, a trackball, or a pointing stick for communicating direction information and command selections to the processor 803 and for controlling cursor movement on the display 810.

The computer system 801 performs a portion or all of the processing steps of the process in response to the processor 803 executing one or more sequences of one or more instructions contained in a memory, such as the main memory 804. Such instructions may be read into the main memory 804 from another computer readable medium, such as a hard disk 807 or a removable media drive 808. One or more processors in a multi-processing arrangement may also be employed to execute the sequences of instructions contained in main memory 804. In alternative embodiments, hard-wired circuitry may be used in place of or in combination with software instructions. Thus, embodiments are not limited to any specific combination of hardware circuitry and software.

As stated above, the computer system 801 includes at least one computer readable medium or memory for holding instructions programmed according to the embodiments presented, for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SD RAM, or any other magnetic medium, compact discs (e.g., CD-ROM), or any other optical medium, punch cards, paper tape, or other physical medium with patterns of holes, or any other medium from which a computer can read.

Stored on any one or on a combination of non-transitory computer readable storage media, embodiments presented herein include software for controlling the computer system 801, for driving a device or devices for implementing the process, and for enabling the computer system 801 to interact with a human user (e.g., print production personnel). Such software may include, but is not limited to, device drivers, operating systems, development tools, and applications software. Such computer readable storage media further includes a computer program product for performing all or a portion (if processing is distributed) of the processing presented herein.

The computer code devices may be any interpretable or executable code mechanism, including but not limited to scripts, interpretable programs, dynamic link libraries (DLLs), Java classes, and complete executable programs. Moreover, parts of the processing may be distributed for better performance, reliability, and/or cost.

The computer system 801 also includes a communication interface 813 coupled to the bus 802. The communication interface 813 provides a two-way data communication coupling to a network link 814 that is connected to, for example, a local area network (LAN) 815, or to another communications network 816 such as the Internet. For example, the communication interface 813 may be a wired or wireless network interface card to attach to any packet switched (wired or wireless) LAN. As another example, the communication interface 813 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 813 sends and receives electrical, electromagnetic or optical signals that carry digital data streams representing various types of information.

The network link 814 typically provides data communication through one or more networks to other data devices. For example, the network link 814 may provide a connection to another computer through a local area network 815 (e.g., a LAN) or through equipment operated by a service provider, which provides communication services through a communications network 816. The local network 814 and the communications network 816 use, for example, electrical, electromagnetic, or optical signals that carry digital data streams, and the associated physical layer (e.g., CAT 5 cable, coaxial cable, optical fiber, etc.). The signals through the various networks and the signals on the network link 814 and through the communication interface 813, which carry the digital data to and from the computer system 801 may be implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 801 can transmit and receive data, including program code, through the network(s) 815 and 816, the network link 814 and the communication interface 813. Moreover, the network link 814 may provide a connection through a LAN 815 to a mobile device 817 such as a personal digital assistant (PDA) laptop computer, or cellular telephone.

In summary, a method is provided comprising: establishing a communication tunnel over a network with a network device; receiving via the communication tunnel, at a tunnel headend, a usage profile reference from the network device; transmitting the usage profile reference to a usage profile storage system; receiving, from the usage profile storage system, a policy, based on the usage profile reference, for filtering network traffic; and enforcing the policy at the tunnel headend on network traffic between the network device and the tunnel headend via the communication tunnel.

In addition, an apparatus is provided comprising: a communication interface configured to enable network communications; a processor coupled with the communication interface, and configured to: establish a communication tunnel over a network with a network device; receive via the communication tunnel, at a tunnel headend, a usage profile reference from the network device; transmit the usage profile reference to a usage profile storage system; receive, from the usage profile storage system, a policy, based on the usage profile reference, for filtering network traffic; and enforce the policy at the tunnel headend on network traffic between the network device and the tunnel headend via the communication tunnel.

Furthermore, one or more non-transitory computer readable storage media encoded with software is provided comprising computer executable instructions and when the software is executed by a processor, the processor is operable to: establish a communication tunnel over a network with a network device; receive via the communication tunnel, at a tunnel headend, a usage profile reference from the network device; transmit the usage profile reference to a usage profile storage system; receive, from the usage profile storage system, a policy, based on the usage profile reference, for filtering network traffic; and enforce the policy at the tunnel headend on network traffic between the network device and the tunnel headend via the communication tunnel.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A computer-implemented method comprising:
establishing a communication tunnel over a network with a network device;
receiving via the communication tunnel, at a tunnel headend, a usage profile reference from the network device;
transmitting the usage profile reference to a usage profile storage system;
receiving, from the usage profile storage system, a policy, based on the usage profile reference, for filtering network traffic; and
enforcing the policy at the tunnel headend on network traffic between the network device and the tunnel headend via the communication tunnel.

2. The computer-implemented method of claim 1, wherein the usage profile reference is a manufacturer usage description (MUD) reference and the usage profile storage system is a MUD server.

3. The computer-implemented method of claim 1, wherein enforcing the policy further comprises negotiating between the tunnel headend and the network device to restrict a type of network traffic that the tunnel headend accepts.

4. The computer-implemented method of claim 1, further comprising:
forwarding the policy to the network device; and
enforcing the policy by the network device.

5. The computer-implemented method of claim 1, further comprising:
generating Internet Key Exchange (IKE) traffic selectors based on the policy to restrict a type of network traffic that the tunnel headend accepts.

6. The computer-implemented method of claim 1, wherein a portion of the communication tunnel traverses at least a part of a mobile or cellular network.

7. The computer-implemented method of claim 1, wherein the communication tunnel is virtual private network (VPN) tunnel.

8. The computer-implemented method of claim 1, wherein the network device is an Internet-of-Things (IoT) gateway.

9. The computer-implemented method of claim 8, wherein the IoT gateway is connected to a plurality of IoT devices, and wherein the usage profile reference is a summary of usage profile references associated with each IoT device connected to the gateway.

10. An apparatus comprising:
a communication interface configured to enable network communications;
a processor coupled with the communication interface, and configured to:
establish a communication tunnel over a network with a network device;
receive via the communication tunnel at a tunnel headend, a usage profile reference from the network device;
transmit the usage profile reference to a usage profile storage system;
receive, from the usage profile storage system, a policy, based on the usage profile reference, for filtering network traffic; and
enforce the policy at the tunnel headend on network traffic between the network device and the tunnel headend via the communication tunnel.

11. The apparatus of claim 10 wherein the usage profile reference is a manufacturer usage description (MUD) reference and the usage profile storage system is a MUD server.

12. The apparatus of claim 10, wherein the processor is configured to enforce the policy by negotiating between a tunnel headend and the network device to restrict a type of network traffic that the tunnel headend accepts.

13. The apparatus of claim 10, wherein the processor is further configured to:
generate Internet Key Exchange (IKE) traffic selectors based on the policy to restrict a type of network traffic that the tunnel headend accepts.

14. The apparatus of claim 10, wherein a portion of the communication tunnel traverses at least a part of a mobile network.

15. The apparatus of claim 10, wherein the network device is an Internet-of-Things (IoT) gateway, wherein the IoT gateway is connected to a plurality of IoT devices, and wherein the usage profile reference is a summary of usage profile references associated with each IoT device connected to the IoT gateway.

16. A non-transitory computer-readable storage media encoded with software comprising computer executable instructions and when the software is executed by a processor, the processor is caused to:
establish a communication tunnel over a network with a network device;
receive via the communication tunnel, at a tunnel headend, a usage profile reference from the network device;
transmit the usage profile reference to a usage profile storage system;
receive, from the usage profile storage system, a policy, based on the usage profile reference, for filtering network traffic; and
enforce the policy at the tunnel headend on network traffic between the network device and the tunnel headend via the communication tunnel.

17. The computer-readable storage media of claim 16, wherein the usage profile reference is a manufacturer usage description (MUD) reference and the usage profile storage system is a MUD server.

18. The computer-readable storage media of claim 16, wherein the instructions that cause the processor to enforce the policy include instructions to cause the processor to negotiate between the tunnel headend and the network device to restrict a type of network traffic that the tunnel headend accepts.

19. The computer-readable storage media of claim 16, further comprising instructions that cause the processor to:
generate Internet Key Exchange (IKE) traffic selectors based on the policy to restrict a type of network traffic that the tunnel headend accepts.

20. The computer-readable storage media of claim 16, wherein a portion of the communication tunnel traverses at least a part of a mobile or cellular network.
